(19) United States
(12) Patent Application Publication
(10) Pub. No.: US 2025/0226713 A1
(43) Pub. Date: Jul. 10, 2025

(54) BALANCED STATOR WINDINGS

(71) Applicant: Rivian IP Holdings, LLC, Irvine, CA (US)

(72) Inventors: Fan Wu, Rancho Palos Verdes, CA (US); Khwaja Rahman, Troy, MI (US); Logan Noel Balliett, Los Angeles, CA (US)

(73) Assignee: Rivian IP Holdings, LLC, Irvine, CA (US)

(21) Appl. No.: 18/404,092

(22) Filed: Jan. 4, 2024

(51) Int. Cl. H02K 3/28; H02K 1/16; H02K 15/085

(52) U.S. Cl. CPC H02K 3/28; H02K 1/16; H02K 15/085

(57) ABSTRACT

A motor can include a stator. The stator can include a first slot associated with a first phase. The first slot can receive an even number of conductors associated with the first phase. The stator can also include a second slot associated with the first phase and a second phase. The second slot can receive a subset of the even number of conductors associated with the first phase and a first number of conductors associated with the second phase.

### INTRODUCTION

Vehicles can include electrical components. The electrical components can be electrically coupled with one another.

### SUMMARY

This disclosure is generally related to one or more components of a vehicle. The components can include at least one motor. The motor can include at least one drive assembly component. For example, the motor can include a stator. The stator can include at least one slot and/or opening. The slots can receive and/or accept conductors. For example, the slots can receive conductors that are associated with one or more electrical phases. The conductors can provide electrical current, electrical voltage, and/or electrical power. The motor can be included with a vehicle or included with one or more vehicle components. For example, the motor can be included in an electric vehicle. To continue this example, the stator can electrically couple with a power source (e.g., a battery) of the electric vehicle.

At least one aspect is directed to a motor. The motor can include a stator. The stator can include a first slot. The first slot can be associated with a first phase. The first slot can receive an even number of conductors associated with the first phase. The stator can also include a second slot. The second slot can be associated with the first phase and a second phase. The second slot can receive a subset of the even number of conductors associated with the first phase and a first number of conductors associated with the second phase.

At least one aspect is directed to a vehicle. The vehicle can include a motor. The motor can include a stator. The stator can include a first slot. The first slot can be associated with a first phase. The first slot can receive an even number of conductors associated with the first phase. The stator can also include a second slot. The second slot can be associated with the first phase and a second phase. The second slot can receive a subset of the even number of conductors associated with the first phase and a first number of conductors associated with the second phase.

At least one aspect is directed to a method. The method can include disposing, in a first slot of a stator, an even number of conductors associated with a first phase. The first slot can be associated with the first phase. The method can also include disposing, in a second slot of the stator, a subset of the even number of conductors associated with the first phase and a first number of conductors associated with a second phase. The second slot can be associated with the first phase and the second phase.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification. The foregoing information and the following detailed description and drawings include illustrative examples and should not be considered as limiting.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 depicts an electric vehicle, in accordance with an implementation.

FIG. 2 is a perspective view of a motor having a stator and one or more conductors, in accordance with an implementation.

FIG. 3 is a perspective view of the motor illustrated in FIG. 2, in accordance with an implementation.

FIG. 4 is a perspective view of the motor illustrated in FIG. 2, in accordance with an implementation.

FIG. 5 is a perspective view of the motor illustrated in FIG. 2, in accordance with an implementation.

FIG. 6 is a perspective view of the motor illustrated in FIG. 2, in accordance with an implementation.

FIG. 7 is a perspective view of the motor illustrated in FIG. 2, in accordance with an implementation.

FIG. 8 is a perspective view of the motor illustrated in FIG. 2, in accordance with an implementation.

FIG. 9 is a flow diagram of a process for manufacturing a stator having one or more conductors, in accordance with an implementation.

### DETAILED DESCRIPTION

Following below are more detailed descriptions of various concepts related to, and implementations of, methods, apparatuses, and systems of a drive unit assembly. The various concepts introduced above and discussed in greater detail below may be implemented in any of numerous ways.

The present disclosure is directed to systems and methods of one or more components for a vehicle. The components can include at least one drive unit assembly. For example, the components can include a stator. The stator can include one or more conductors. For example, the stator can include conductors that provide electrical power. The stator can include or provide a three-phase electric system. For example, the stator can include conductors that are associated with one or more phases.

The stator can include one or more slots. For example, the stator can include a first slot and a second slot. The slots can receive one or more conductors. For example, the first slot can receive a first number of conductors and the second slot can receive a second number of conductors. The conductors can be associated with one or more phases. For example, the first number of conductors can be associated with a first phase and the second number of conductors can be associated with a second phase.

The conductors can be positioned and/or located across or within the stator based on one or more patterns. For example, a first slot of the stator can receive conductors associated with a first phase. To continue this example, a second slot of the stator can be positioned proximate to a first side of the first slot and a second slot of the stator can be positioned proximate to a second side of the first slot. The second slot can be associated with the first phase and a second phase. The third slot can be associated with the first phase and the third phase. The placement of conductors, according to phase, can include at least one pattern. The conductors can also include a staggered and/or alternating pattern. For example, a first slot can receive a first number of conductors. To continue this example, a second slot can receive a first subset of the first number of conductors and a second slot can receive a second subset of the first number of conductors.

Conductor placement, within a stator, can impact magnetomotive force (MMF) harmonics. For example, stators that included an unbalanced conductor placement can produce harmonic noise. Harmonic noise can impact a performance of the stator. For example, harmonic noise may interfere with a magnetic field that is produced by the stator. Unbalanced conductor placement can occur when conductors are not distributed equally across one or more slots. For example, a first slot can include six conductors. To continue this example, an unbalanced conductor placement can occur when a second slot receives two conductors, of the six conductors, and when a third slot receives the remaining four conductors. This pattern can be repeated or continued across the stator. The repetition of this staggered pattern can further impact harmonic noise.

Some technical solutions of the present disclosure include providing a stator that includes conductors having a balanced winding pattern. For example, a first slot can receive six conductors and the six conductors can be equally distributed to a second slot and a third slot. The balanced winding pattern of the conductors can reduce harmonic noise within a vehicle. The conductors can be shaped, designed, arranged, and/or otherwise assembled which results in a first conductor have a similar location in a first slot and a second slot. For example, a first slot can receive six conductors, each conductor can have a placement or position within the first slot. The placement can include a layer. For example, a first conductor can be placed and/or positioned at a first layer within the slot. To continue this example, a second conductor can be placed and/or positioned as a second layer within the slot, and so on and so forth. The assembly of the conductors can result in a first conductor having a similar layer position in a first slot and a second slot. For example, a first conductor that is located in a first layer of a first slot can also be located in a first layer of a second slot.

The assembly of the conductors can provide space or room for one or more conductors to jump and/or switch layers. For example, a first conductor can be located in a second layer of a first slot and the first conductor can also be located in a third layer of a second slot. The adjustability or modularity of the conductors can result in the stator having conductors with a balanced winding. For example, a first conductor can be at a first layer within a first slot and a second layer with a second slot to provide room for one or more additional conductors to be located in the first slot or the second slot. The additional room for subsequent conductors can provide a balanced winding.

The balanced stator winding pattern can refer to or include a number of layers that follows a formula of (2n+1)*2, with n being a natural number. For example, n can be equal to one and in this example the number of layers would then be six. The number of layers can refer to a number of conductors located within one or more slots. For example, a six-layer system can refer to stator that includes six conductors per slot. The balanced stator winding can include one or more layered systems. For example, the stator can include 10 layers per slot (e.g., n equals two). As another example, the stator can include 14 layers per slot (e.g., n equals three).

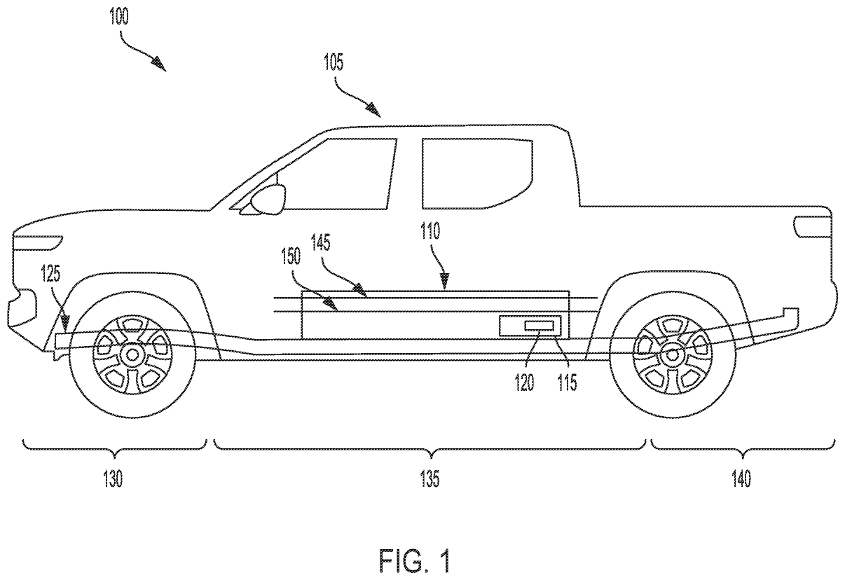

FIG. 1 depicts an example cross-sectional view 100 of an electric vehicle 105 installed with at least one battery pack 110. Electric vehicles 105 can include electric trucks, electric sport utility vehicles (SUVs), electric delivery vans, electric automobiles, electric cars, electric motorcycles, electric scooters, electric passenger vehicles, electric passenger or commercial trucks, hybrid vehicles, or other vehicles such as sea or air transport vehicles, planes, helicopters, submarines, boats, or drones, among other possibilities. The battery pack 110 can also be used as an energy storage system to power a building, such as a residential home or commercial building. Electric vehicles 105 can be fully electric or partially electric (e.g., plug-in hybrid) and further, electric vehicles 105 can be fully autonomous, partially autonomous, or unmanned. Electric vehicles 105 can also be human operated or non-autonomous. Electric vehicles 105 such as electric trucks or automobiles can include on-board battery packs 110, batteries 115 or battery modules 115, or battery cells 120 to power the electric vehicles. The electric vehicle 105 can include a chassis 125 (e.g., a frame, internal frame, or support structure). The chassis 125 can support various components of the electric vehicle 105. The chassis 125 can span a front portion 130 (e.g., a hood or bonnet portion), a body portion 135, and a rear portion 140 (e.g., a trunk, payload, or boot portion) of the electric vehicle 105. The battery pack 110 can be installed or placed within the electric vehicle 105. For example, the battery pack 110 can be installed on the chassis 125 of the electric vehicle 105 within one or more of the front portion 130, the body portion 135, or the rear portion 140. The battery pack 110 can include or connect with at least one busbar, e.g., a current collector element. For example, the first busbar 145 and the second busbar 150 can include electrically conductive material to connect or otherwise electrically couple the battery 115, the battery modules 115, or the battery cells 120 with other electrical components of the electric vehicle 105 to provide electrical power to various systems or components of the electric vehicle 105.

The battery pack 110 can provide power to electric vehicle 105. Battery packs 110 can include any arrangement or network of electrical, electronic, mechanical or electromechanical devices to power a vehicle of any type, such as the electric vehicle 105. The battery pack 110 can include at least one housing. The housing can include at least one battery module 115 or at least one battery cell 120, as well as other battery pack components. The battery module 115 can be or can include one or more groups of prismatic cells, cylindrical cells, pouch cells, or other form factors of battery cells 120. The housing can include a shield on the bottom or underneath the battery module 115 to protect the battery module 115 and/or cells 120 from external conditions, for example if the electric vehicle 105 is driven over rough terrains (e.g., off-road, trenches, rocks, etc.) The battery pack 110 can include at least one cooling line that can distribute fluid through the battery pack 110 as part of a thermal/temperature control or heat exchange system that can also include at least one thermal component (e.g., cold plate). The thermal component can be positioned in relation to a top submodule and a bottom submodule, such as in between the top and bottom submodules, among other possibilities. The battery pack 110 can include any number of thermal components. For example, there can be one or more thermal components per battery pack 110, or per battery module 115. At least one cooling line can be coupled with, part of, or independent from the thermal component.

The battery modules 115 can each include a plurality of battery cells 120. The battery modules 115 can be disposed within the housing of the battery pack 110. The battery modules 115 can include battery cells 120 that are cylindrical cells or prismatic cells, for example. The battery module 115 can operate as a modular unit of battery cells 120. For example, a battery module 115 can collect current or electrical power from the battery cells 120 that are included in the battery module 115 and can provide the current or electrical power as output from the battery pack 110. The battery pack 110 can include any number of battery modules 115. For example, the battery pack can have one, two, three, four, five, six, seven, eight, nine, ten, eleven, twelve or other number of battery modules 115 disposed in the housing.

The battery modules 115 can be square, rectangular, circular, triangular, symmetrical, or asymmetrical. In some examples, battery modules 115 may be different shapes, such that some battery modules 115 are rectangular but other battery modules 115 are square shaped, among other possibilities. The battery module 115 can include or define a plurality of slots, holders, or containers for a plurality of battery cells 120. It should be noted the illustrations and descriptions herein are provided for example purposes and should not be interpreted as limiting.

The battery cell 120 can be included in battery modules 115 or battery packs 110 to power components of the electric vehicle 105. The housing can be disposed in the battery module 115, the battery pack 110, or a battery array installed in the electric vehicle 105. The battery cell housing can be of any shape, such as cylindrical with a circular, elliptical, or ovular base, among others. The shape of the housing can also be prismatic with a polygonal base. The housing can include a pouch form factor. The housing can include other form factors, such as a triangle, a square, a rectangle, a pentagon, and a hexagon, among others. In some embodiments, the battery pack may not include modules (e.g., module-free). For example, the battery pack can have a module-free or cell-to-pack configuration where the battery cells are arranged directly into a battery pack without assembly into a module.

Current collector materials (e.g., a current collector foil to which an electrode active material is laminated to form a cathode layer or an anode layer) can include a metal material. For example, current collector materials can include aluminum, copper, nickel, titanium, stainless steel, or carbonaceous materials. The current collector material can be formed as a metal foil. For example, the current collector material can be an aluminum (Al) or copper (Cu) foil. The current collector material can be a metal alloy, made of Al, Cu, Ni, Fe, Ti, or combination thereof. The current collector material can be a metal foil coated with a carbon material, such as carbon-coated aluminum foil, carbon-coated copper foil, or other carbon-coated foil material.

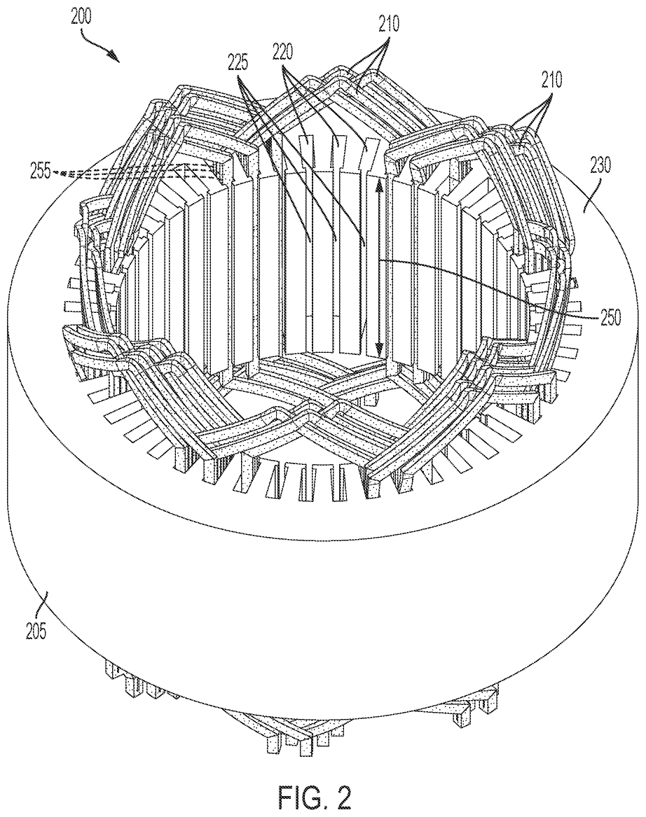

FIG. 2 depicts a perspective view of a motor 200. The motor 200 can be coupled with a vehicle. For example, the motor 200 can be coupled with the vehicle 105. The motor 200 can be included with the vehicle 105. For example, the motor 200 can be disposed within the vehicle 105. The motor 200 can be provided as one or more components for the vehicle 105. For example, the motor 200 can be disposed within the vehicle 105 subsequent to assembly of the vehicle 105. The motor 200 can include one or more electrical components. For example, the motor 200 can include components that can couple with a power source (e.g., the batteries 115). The motor can include at least one stator 205. The stator 205 can be included in or provided as a drive unit assembly. The stator 205 can electrically couple with one or more components. For example, the stator can electrically couple with an inverter. As another example, the stator 205 can be electrically coupled with the batteries 115.

The stator 205 can include at least one slot 220 and at least one face 230. The slots 220 can include and/or define at least one cavity 225. The slots 220 can receive or accept at least one conductor 210. The conductors 210 can include the conductors described herein. The stator 205 can include one or more slots 220 and the one or more slots 220 can be associated with one or more phases. For example, the stator 205 can include a first slot 220 and a second slot 220. To continue this example, the first slot 220 can be associated with a first phase and the second slot 220 can be associated with a first phase. The slots 220 can be associated with one or more phases based on a placement of a given slot 220 within the stator 205. The slots 220 can be associated with one or more phases responsive to a given slot 220 receiving or accepting one or more conductors 210 associated with a given phase.

The slots 220 can include varying numbers or quantities of conductors 210. For example, a first slot 220 can receive a first number of conductors. To continue this example, the first number of conductors can be associated with a first phase. The numbers or quantities of conductors 210 can include different amounts. For example, the slots 220 can receive given amounts of conductors 210 and the given amounts of conductors 210 can be subsets or combinations of conductors 210 associated with one or more phases. Stated otherwise the slots 220 can receive conductors 210 associated with a given phase or the slots 220 can receive conductors 210 that are associated with at least one of a first phase, a second phase, or a second phase.

The slots 220 can receive a total or combined even number of conductors 210. For example, a first slot 220 can receive an even number of conductors 210 associated with a given phase. As another example, a second slot 220 can receive a subset of the even number of conductors 210 associated with the given phase. The slots 220 can be associated with a single phase or the slots 220 can be associated with multiple phases. For example, a first slot 220 can be associated with a signal phase when the first slot 220 receives a given number of conductors 210 to fill or occupy the cavity 225 for the first slot 220. As a non-limiting example, the cavity 225 can accommodate or provide room for six conductors 210. To continue this non-limiting example, the first slot 220 can receive the six conductors 210 (e.g., an even number of conductors). In this non-limiting example, the first slot 220 can be associated with a single given phase responsive to the six conductors 210 being associated with a single phase. Reference number 255 represents one or more layers for the slots 220. For example, a single layer 255 can correspond to a position and/or placement of a conductor 210 within a given slot 220. The layers 255 can include various placements, arrangements, or positioning. For example, as shown in FIG. 2, a slot 220 is shown to have three layers 255 with each layer 255 corresponding to a given conductor 210. The layer 255 that is closet to a center point (e.g., center of the void or opening) of the stator 205 can be considered a first layer or a front layer. The numberings of the layer 255 can follow one or more patterns.

FIG. 2 provides an example of the conductors 210 being associated with a single given phase. For example, the conductors 210 can be associated with the first phase. As shown in FIG. 2, the conductors 210 associated with the first phase are grouped and/or bunched in groups of three slots 220. For example, three adjacent slots 220 can receive conductors associated with the first phase. As shown in FIG. 2, a middle slot 220 of the bunched slots 220 can receive a number of conductors 210 to occupy the cavity 225. For example, the middle slot 220 is shown to have received six conductors 210. Each adjacent slot 220, relative to the middle slot 220, can receive a subset of conductors 210 that are associated with the first phase. For example, as shown in FIG. 2, each adjacent slot 220 is shown to have received three conductors 210 that are associated with the first phase. To continue this example, a first adjacent slot 220 can receive one or more additional conductors 210 that are associated with the second phase or the third phase. Stated otherwise the adjacent slots 220 can receive subsequent conductors 210 that are associated with the second phase or the third phase.

The cavities 225 can receive at least a portion of the conductors 210. For example, the conductors 210 can include a rod or rail that extends along a longitudinal distance and the rods can be inserted into the cavities 225. The conductors 210 can run or extend across the cavities 225. A first portion of the conductors 210 can be positioned external to a first face 230 and a second portion of the conductors 210 can be positioned external to a second face 230. For example, the conductors 210 or a portion thereof can be positioned external to a top and a bottom of the stator 205. The conductors 210 or a portion thereof can extend along plane 250. For example, the conductors 210 can extend from a first face 230 to a second face 230 along the plane 250.

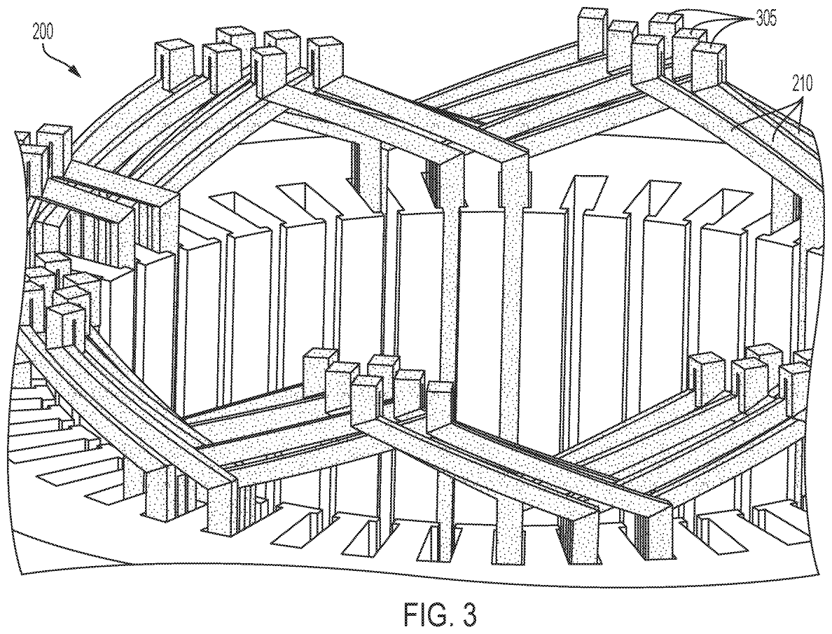

FIG. 3 is a perspective view of the motor 200. The perspective view, as shown in FIG. 3, includes an enlarged view of the conductors 210. The conductors 210 can include at least one protrusions 305 or extension 305. The protrusions 305 can electrically couple with one or more components. For example, the protrusions 305 can couple with a busbar. As another example, the protrusions can indirectly electrically couple with the batteries 115. The conductors 210 can include one or more arrangements or assemblies. For example, the conductors 210 can have at least one of a wishbone arrangement, a hairpin arrangement, a triangle arrangement, a pyramid arrangement, or other possible combinations.

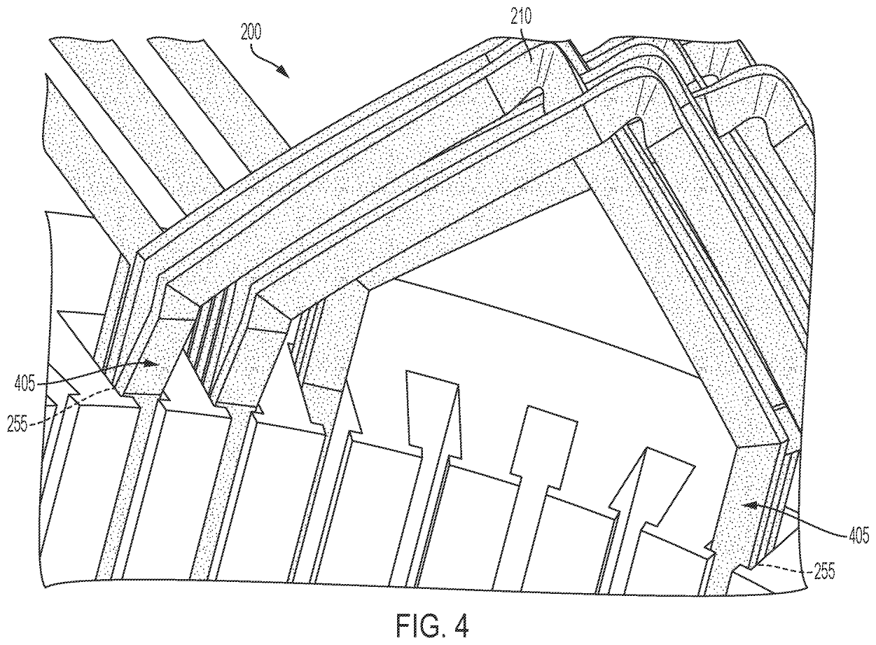

FIG. 4 is a perspective view of the motor 200. The perspective view, as shown in FIG. 4, includes an enlarged view of the conductors 210. The conductors 210 can include one or more portions 405 or segments 405. The segments 405 can be inserted into or received by the slots 220. As shown in FIG. 4, the stator 205 includes a bundled set of three slots 220 with each slot 220 having various amounts of conductors 210. A leftmost slot 220 is shown to have three conductors 210. The three conductors 210 are located in a first layer 255 (e.g., layer 1), a second layer 255 (e.g., layer 2), and a third layer 255 (e.g., layer 3) respectively. A middle slot 220 is shown to have six conductors 210. The six conductors are located in six layers 255 (e.g., layers 1-6). A rightmost slot 220 is shown to have three conductors 210. The conductors 210 are located in a fourth layer 255 (e.g., layer 4), a fifth layer 255 (e.g., layer 5), and a sixth layer 255 (e.g., layer 6) respectively.

As a non-limiting example, the middle slot 220 can receive six conductors 210 associated with a first phase. To continue this non-limiting example, the leftmost slot 220 can receive three conductors 210 associated with the first phase and three conductors associated with a second phase. Furthermore, to continue this non-limiting example, the rightmost slot 220 can receive three conductors 210 associated with the first phase and three conductors associated with a third phase.

FIG. 4 shows an example of a slot 220 having or received a subset of the conductors 210 included in the slot 220 having the six conductors 210. For example, the middle slot 220 of the bundled slots 220 can include a first portion 405 of all six conductors 210 and the subsequent slot 220 can include a second portion 405 of three out of the six conductors 210 (e.g., a subset).

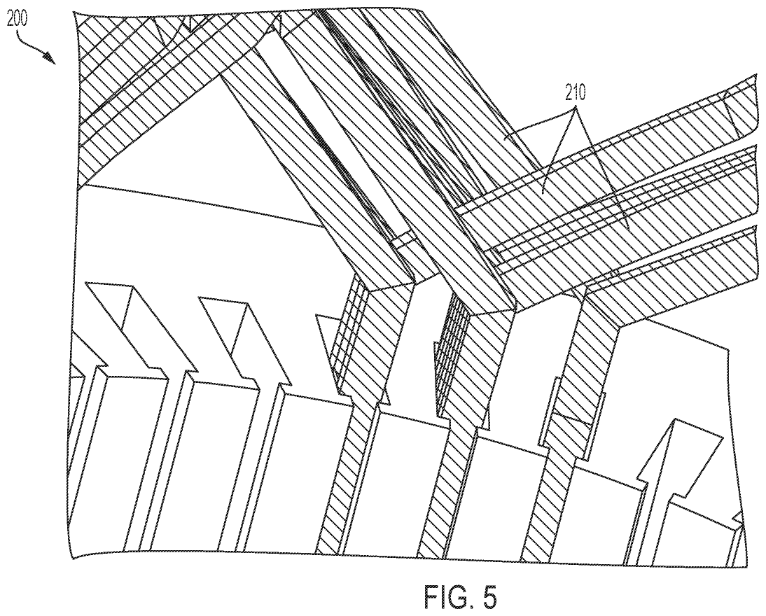

FIG. 5 is a perspective view of the motor 200. FIG. 5 depicts an example of the stator 205 including one or more conductors 210 associated with a phase that is different than a phase of the conductors 210 shown in FIGS. 2-4. For example, FIGS. 2-4 can refer to conductors 210 that are associated with a first phase and FIG. 5 can refer to conductors 210 that are associated with a second phase. FIG. 5 depicts an example of the stator 205 including bundled slots 220. For example, three slots 220 are shown to have various numbers of conductors 210. The leftmost slot 220 is shown to include three conductors 210 associated with the second phase. The leftmost slot 220 can receive three subsequent conductors 210 associated with the first phase or the third phase. The middle slot 220 is shown to include six conductors 210 associated with the second phase. The rightmost slot 220 is shown to include three conductors 210 associated with the second phase. The rightmost slot 220 can receive three subsequent conductors 210 associated with the first phase or the third phase.

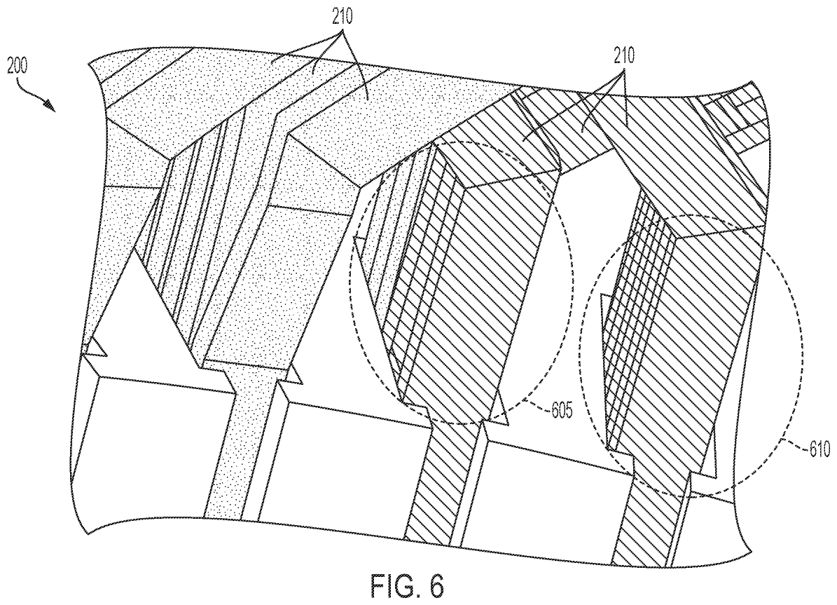

FIG. 6 is a perspective view of the motor 200. FIG. 6 depicts an example of the stator 205 including one or more first conductors 210 associated with a first phase and one or more second conductors 210 associated with a second phase. FIG. 6 is shown to include highlighted portion 605 and highlighted portion 610. The highlighted portion 605 illustrates an example of a slot 220 that includes a number of conductors 210 associated with a first phase and includes a number of conductors 210 associated with a second phase.

As shown in FIG. 6, the three conductors 210 associated with a first given phase are located in the first three layers 255 and the three conductors 210 associated with a second given phase are in the last three layers 255. The highlighted portion 610 illustrates an example of a second slot 220 that includes a number of conductors 210 associated with a single phase. For example, the second slot 220 includes six conductors 210 and each conductor 210 are associated with the same phase.

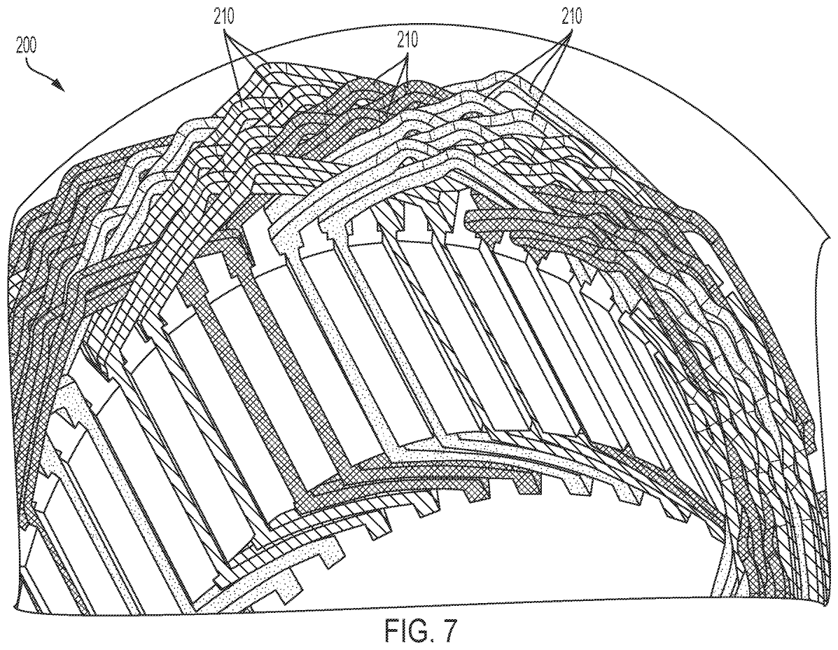

FIG. 7 is a perspective view of the motor 200. FIG. 7 depicts an example of the stator 205 including one or more first conductors 210 associated with a first phase, one or more second conductors 210 associated with a second phase, and one or more third conductors 210 associated with a third phase. The stator 205 can include at least one pattern or arrangement. For example, the stator 205 can include a staggered arrangement of conductors 210. Stated otherwise, the position and/or placement of the conductors 210 can be staggered across the stator 205. The staggered pattern can include the bundled slots described herein. For example, three adjacent slots 220 can have a middle slot 220 which each layer 255 occupied by conductors 210 associated with a first given phase. To continue this example, a leftmost slot 220 can have conductors 210 associated with the first given phase and a second given phase. Furthermore, a rightmost slot 220 can have conductors 210 associated with the first given phase and a third given phase. This bundled slot design can be repeated and/or reused for one or more slots 220 associated with various regions.

The pattern of the conductors 210 can include one or more predetermined or prearranged patterns. For example, a first conductor 210 can have a first portion 405 that is positioned in a first layer 255 of a first slot 220 and the first conductor 210 can have a second portion 405 that is positioned in a first layer 255 of a second slot 220. As another example, a second conductor 210 can have a first portion 405 that is positioned in a second layer 255 of the first slot 220 and the second conductor 210 can have a second portion 405 that is positioned in a third layer 255 of the second slot 220.

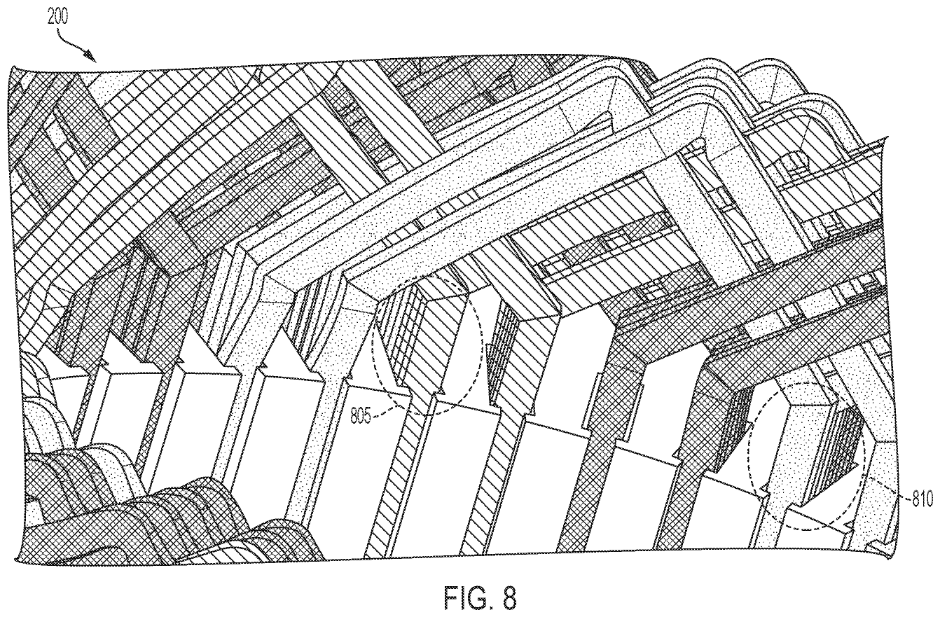

FIG. 8 is a perspective view of the motor 200. FIG. 8 depicts an example of the stator 205 including one or more first conductors 210 associated with a first phase, one or more second conductors 210 associated with a second phase, and one or more third conductors 210 associated with a third phase. FIG. 8 is shown to include highlighted portion 805 and highlighted portion 810. The highlighted portion 805 illustrates an example of a slot 220 that includes a number of conductors associated with a first given phase and includes a number of conductors 210 associated with a second given phaser. The highlighted portion 810 illustrates an example of a second slot 220 that includes a number of conductors associated with a third given phase and includes a number of conductors associated with either the first given phase or the second given phase.

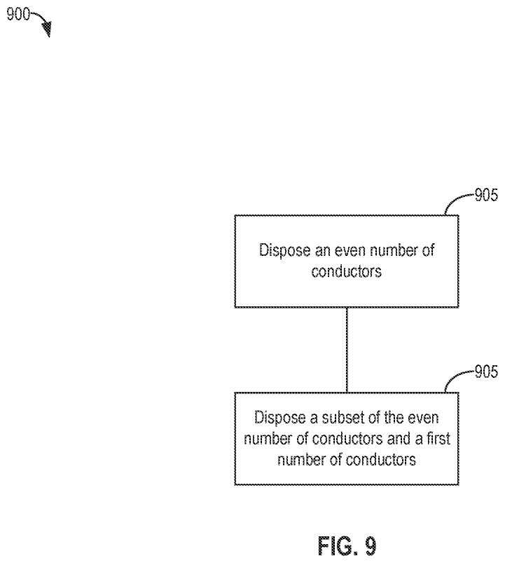

FIG. 9 is a flow diagram of a process 900 for manufacturing a stator. The stator can include the stator 205. The manufacturing of the stator 205 can include providing the stator 205. For example, the stator 205 can be provided during assembly of the vehicle 105. The stator 205 can be provided responsive to the stator 205 having been purchase.

At act 905, an even number of conductors can be disposed. For example, an even number of conductors 210 can be disposed. The even number of conductors 210 can be disposed within a slot 220. The even number of conductors 210 can be disposed within the slot 220 by at least one of placing, positioning, locating, or otherwise situating the even number of conductors 210 within the slot 220. The slot 220 can be associated with a given phase. For example, the slot 220 can be associated with the first phase. The even number of conductors 210 can be associated with the first phase. The even number of conductors 210 can include six conductors.

At act 910, a subset of the even number of conductors and a first number of conductors can be disposed. For example, a subset of the even number of conductors 210 disposed within the slot 220, in act 905, can also be disposed withing a second slot 220. As another example, a first portion 405 of the even number of conductors 210 can be disposed within the slot 220 and a second portion 405 of the subset of the even number of conductors 210 can be disposed within a second slot 220. The subset of the even number of conductors 210 and the first number of conductors can be disposed within the second slot 220 by at least one of placing, positioning, locating, or otherwise situating the subset of the even number of conductors 210 and the first number of conductors within the slot 220.

The subset of the even number of conductors 210 can include three conductors. The first number of conductors can include one or more conductors 210. For example, the first number of conductors 210 can include three conductors. The subset of the even number of conductors 210 can be associated with the first phase. The first number of conductors 210 can be associated with the second phase. The second slot 220 can be associated with the first phase and the second phase.

Some of the description herein emphasizes the structural independence of the aspects of the system components or groupings of operations and responsibilities of these system components. Other groupings that execute similar overall operations are within the scope of the present application. Modules can be implemented in hardware or as computer instructions on a non-transient computer readable storage medium, and modules can be distributed across various hardware or computer based components.

The systems described above can provide multiple ones of any or each of those components and these components can be provided on either a standalone system or on multiple instantiation in a distributed system. In addition, the systems and methods described above can be provided as one or more computer-readable programs or executable instructions embodied on or in one or more articles of manufacture. The article of manufacture can be cloud storage, a hard disk, a CD-ROM, a flash memory card, a PROM, a RAM, a ROM, or a magnetic tape. In general, the computer-readable programs can be implemented in any programming language, such as LISP, PERL, C, C++, C#, PROLOG, or in any byte code language such as JAVA. The software programs or executable instructions can be stored on or in one or more articles of manufacture as object code.

Example and non-limiting module implementation elements include sensors providing any value determined herein, sensors providing any value that is a precursor to a value determined herein, datalink or network hardware including communication chips, oscillating crystals, communication links, cables, twisted pair wiring, coaxial wiring, shielded wiring, transmitters, receivers, or transceivers, logic circuits, hard-wired logic circuits, reconfigurable logic circuits in a particular non-transient state configured according to the module specification, any actuator including at least an electrical, hydraulic, or pneumatic actuator, a solenoid, an op-amp, analog control elements (springs, filters, integrators, adders, dividers, gain elements), or digital control elements.

The subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices include cloud storage). The operations described in this specification can be implemented as operations performed by a data processing apparatus on data stored on one or more computer-readable storage devices or received from other sources.

The terms “computing device”, “component” or “data processing apparatus” or the like encompass various apparatuses, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA (field programmable gate array) or an ASIC (application specific integrated circuit). Devices suitable for storing computer program instructions and data can include non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

The subject matter described herein can be implemented in a computing system that includes a back end component, e.g., as a data server, or that includes a middleware component, e.g., an application server, or that includes a front end component, e.g., a client computer having a graphical user interface or a web browser through which a user can interact with an implementation of the subject matter described in this specification, or a combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

For example, descriptions of positive and negative electrical characteristics may be reversed. Elements described as negative elements can instead be configured as positive elements and elements described as positive elements can instead by configured as negative elements. For example, elements described as having first polarity can instead have a second polarity, and elements described as having a second polarity can instead have a first polarity. Further relative parallel, perpendicular, vertical or other positioning or orientation descriptions include variations within +/−10% or +/−10 degrees of pure vertical, parallel or perpendicular positioning. References to “approximately,” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

What is claimed is:

1. A motor, comprising:
a stator, including:
a first slot associated with a first phase, the first slot configured to receive an even number of conductors associated with the first phase; and
a second slot associated with the first phase and a second phase, the second slot configured to receive a subset of the even number of conductors associated with the first phase and a first number of conductors associated with the second phase.

2. The motor of claim 1, comprising:
the subset of the even number of conductors associated with the first phase located in a first position of the second slot;
the first number of conductors associated with the second phase located in a second position of the second slot; and
the second position of the second slot distal to a center portion of the stator relative to the first position of the second slot.

3. The motor of claim 1, comprising:
the stator, including:
a third slot located proximate to the second slot, the third slot associated with the second phase and a third phase, and the third slot configured to receive a second number of conductors associated with the second phase and a third number of conductors associated with the third phase;
the first number of conductors associated with the second phase disposed between the subset of the even number of conductors associated with the first phase and a center portion of the stator; and
the second number of conductors associated with the second phase disposed between the third number of conductors associated with the third phase and the center portion of the stator.

4. The motor of claim 1, wherein:
the even number of conductors associated with the first phase include six conductors;
the subset of the even number of conductors associated with the first phase include three conductors;
the stator includes a third slot configured to receive a second subset of the even number of conductors associated with the first phase; and
the second subset of the even number of conductors associated with the first phase include three conductors different from the subset of the even number of conductors associated with the first phase.

5. The motor of claim 1, comprising:
the stator, including:
a third slot associated with the first phase and a third phase, the third slot configured to receive a second subset of the even number of conductors associated with the first phase and a second number of conductors associated with the third phase;
the subset of the even number of conductors associated with the first phase different than the second subset of the even number of conductors associated with the first phase.

6. The motor of claim 1, comprising:
the stator, including:
a third slot disposed between a fourth slot of the stator and a fifth slot of the stator, the third slot associated with a third phase, and the third slot configured to receive a second even number of conductors associated with the third phase;
the fourth slot associated with the first phase and the third phase, and the fourth slot configured to receive a second subset of the even number of conductors associated with the first phase and a second number of conductors associated with the third phase;
the fifth slot associated with the second phase and the third phase, and the fifth slot configured to receive a third number of conductors associated with the second phase and a fourth number of conductors associated with the third phase;
wherein the even number of conductors associated with the first phase and the second even number of conductors associated with the third phase are different.

7. The motor of claim 1, comprising:
the stator, including:
a third slot disposed proximate to a first side of the first slot, the third slot associated with the first phase and the second phase, and the third slot configured to receive a second number of conductors associated with the first phase and a third number of conductors associated with the second phase;
wherein the third number of conductors associated with the second phase and the first number of conductors associated with the second phase are different.

8. The motor of claim 7, comprising:
the stator, including:
a fourth slot disposed proximate to a second side of the first slot, the fourth slot associated with the first phase and a third phase, and the fourth slot configured to receive a fourth number of conductors associated with the first phase and a fifth number of conductors associated with the third phase;
the fourth number of conductors associated with the first phase different than the second number of conductors associated with the first phase;
the second number of conductors associated with the first phase positioned at a first distance from a center point of the stator;
the fourth number of conductors associated with the first phase positioned at a second distance from the center point of the stator; and
the first distance from the center point of the stator different than the second distance from the center point of the stator.

9. The motor of claim 1, comprising:
the stator including a first face and a second face;
the first slot including a cavity configured to receive at least a portion of the even number of conductors associated with the first phase; and
the even number of conductors associated with the first phase configured to extend along the cavity of the first slot to position a first portion of the even number of conductors associated with the first phase external to the first face of the stator and a second portion of the even number of conductors associated with the first phase external to the second face of the stator.

10. The motor of claim 1, wherein the motor includes three phases, wherein the three phases include the first phase, the second phase, and a third phase, and further comprising:
the stator, including:
a pattern to define a placement of a first plurality of conductors associated with the first phase relative to a placement of at least one of a second plurality of conductors associated with the second phase or a third plurality of conductors associated with the third phase;
the first plurality of conductors associated with the first phase include the even number of conductors associated with the first phase; and
the second plurality of conductors associated with the second phase include the first number of conductors associated with the second phase.

11. The motor of claim 1, wherein the motor includes three phases, wherein the three phases include the first phase, the second phase, and a third phase, and further comprising:
the stator, including:
a first plurality of conductors associated with the first phase, the first plurality of conductors including the even number of conductors associated with the first phase;
the first plurality of conductors associated with the first phase disposed within a plurality of slots of the stator, the plurality of slots including the first slot and the second slot;
the first plurality of conductors associated with the first phase disposed within the plurality of slots based on a predetermined pattern; and
the predetermined pattern to define one or more first slots of the plurality of slots associated with the first phase, one or more second slots of the plurality of slots associated with the first phase and the second phase, one or more third slots of the plurality of slots associated with the first phase and the third phase, one or more fourth slots of the plurality of slots associated with the second phase, and one or more fifth slots of the plurality of slots associated with the third phase.

12. The motor of claim 1, wherein a number of conductors included in the even number of conductors is based on a stator winding pattern.

13. A vehicle, comprising:
a motor, including:
a stator, including:
a first slot associated with a first phase, the first slot configured to receive an even number of conductors associated with the first phase; and
a second slot associated with the first phase and a second phase, the second slot configured to receive a subset of the even number of conductors associated with the first phase and a first number of conductors associated with the second phase.

14. The vehicle of claim 13, comprising:
the subset of the even number of conductors associated with the first phase located in a first position of the second slot;
the first number of conductors associated with the second phase located in a second position of the second slot; and
the second position of the second slot distal to a center portion of the stator relative to the first position of the second slot.

15. The vehicle of claim 13, comprising:
the stator, including:
a third slot located proximate to the second slot, the third slot associated with the second phase and a third phase, and the third slot configured to receive a second number of conductors associated with the second phase and a third number of conductors associated with the third phase;
the first number of conductors associated with the second phase disposed between the subset of the even number of conductors associated with the first phase and a center portion of the stator; and
the second number of conductors associated with the second phase disposed between the third number of conductors associated with the third phase and the center portion of the stator.

16. The vehicle of claim 13, comprising:
the stator, including:
a third slot associated with the first phase and a third phase, the third slot configured to receive a second subset of the even number of conductors associated with the first phase and a second number of conductors associated with the third phase;
the subset of the even number of conductors associated with the first phase different than the second subset of the even number of conductors associated with the first phase.

17. The vehicle of claim 13, comprising:
the stator, including:
a third slot disposed between a fourth slot of the stator and a fifth slot of the stator, the third slot associated with a third phase, and the third slot configured to receive a second even number of conductors associated with the third phase;
the fourth slot associated with the first phase and the third phase, and the fourth slot configured to receive a second subset of the even number of conductors associated with the first phase and a second number of conductors associated with the third phase;
the fifth slot associated with the second phase and the third phase, and the fifth slot configured to receive a third number of conductors associated with the second phase and a fourth number of conductors associated with the third phase;
wherein the even number of conductors associated with the first phase and the second even number of conductors associated with the third phase are different.

18. The vehicle of claim 13, comprising:
the stator, including:
a third slot disposed proximate to a first side of the first slot, the third slot associated with the first phase and the second phase, and the third slot configured to receive a second number of conductors associated with the first phase and a third number of conductors associated with the second phase;
wherein the third number of conductors associated with the second phase and the first number of conductors associated with the second phase are different.

19. The vehicle of claim 18, comprising:
the stator, including:
a fourth slot disposed proximate to a second side of the first slot, the fourth slot associated with the first phase and a third phase, and the fourth slot configured to receive a fourth number of conductors associated with the first phase and a fifth number of conductors associated with the third phase;
the fourth number of conductors associated with the first phase different than the second number of conductors associated with the first phase;
the second number of conductors associated with the first phase positioned at a first distance from a center point of the stator;
the fourth number of conductors associated with the first phase positioned at a second distance from the center point of the stator; and
the first distance from the center point of the stator different than the second distance from the center point of the stator.

20. A method, comprising:
disposing, in a first slot of a stator, an even number of conductors associated with a first phase, the first slot associated with the first phase; and
disposing, in a second slot of the stator, a subset of the even number of conductors associated with the first phase and a first number of conductors associated with a second phase, the second slot associated with the first phase and the second phase.
